(19) United States
(12) Patent Application Publication
(10) Pub. No.: US 2014/0188704 A1
(43) Pub. Date: Jul. 3, 2014

(54) ALLOWING A CUSTOMER TO OBTAIN A NEW CARD NUMBER USING A MOBILE INTERFACE

(71) Applicant: BANK OF AMERICA CORPORATION, Charlotte, NC (US)

(72) Inventors: Glenn Grossman, Matthews, NC (US); Tamara S. Kingston, Peoria, AZ (US); Stacy A. Maschhoff, Smithton, IL (US)

(73) Assignee: Bank of America Corporation, Charlotte, NC (US)

(21) Appl. No.: 13/732,375

(22) Filed: Jan. 1, 2013

(51) Int. Cl. G06Q 20/34

(52) U.S. Cl. CPC G06Q 20/354
USPC 705/39; 705/35

(57) ABSTRACT

A system provides a new card number to a customer by receiving a customer request for a new card number and electronically transmitting the new card number to a mobile device associated with the customer. In some cases, the system initiates creation of a physical card corresponding to the electronically transmitted new card number; and initiates shipping of the created physical card to a physical address associated with the customer. In some cases, the new card number is electronically transmitted to a mobile wallet application running on the mobile device associated with the customer. The request may include a customer request for a new card number associated with a new account, and the system determines that the customer has been pre-approved for a new account, initiates opening of the new account and initiates creation of a physical card corresponding to the electronically transmitted new card number and the new account.

### BACKGROUND

Customers of financial institutions traditionally must wait for a physical debit or credit card to be created and shipped to the customer before having an opportunity to use the newly issued number associated with the physical debit or credit card.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, and computer program products for providing a new card number to a customer.

According to embodiments of the invention, a system comprises a memory device storing computer executable code; and a processing device to execute the computer executable code to cause the processing device to receive a customer request for a new card number; and electronically transmit the new card number to a mobile device associated with the customer.

In some embodiments, the computer executable code is further to cause the processing device to initiate creation of a physical card corresponding to the electronically transmitted new card number; and initiate shipping of the created physical card to a physical address associated with the customer. In some embodiments, the electronically transmitted new card number is configured for use as a payment instrument. In some embodiments, the new card number is electronically transmitted to a mobile wallet application running on the mobile device associated with the customer. In some embodiments, the customer request for a new card number comprises a customer request for a new card number associated with a new account; and wherein the computer executable code is further to cause the processing device to determine that the customer has been pre-approved for a new account; initiate opening of the new account; initiate creation of a physical card corresponding to the electronically transmitted new card number and the new account; and initiate shipping of the created physical card to a physical address associated with the customer.

In some embodiments, the computer executable code is further to cause the processing device to initiate creation of a physical card having a physical card number different from the electronically transmitted new card number; and initiate shipping of the created physical card to a physical address associated with the customer; wherein the electronically transmitted new card is configured to expire after a period of time. In some such embodiments, the period of time is based at least in part on a shipping time associated with the created physical card or activation of the created physical card.

According to embodiments of the invention, a computer program product is configured for providing a new card number to a customer, where the computer program product comprises a non-transitory computer readable medium comprising computer-executable instructions stored therein. The computer-executable instructions are to cause a processing device to receive a customer request for a new card number; and electronically transmit the new card number to a mobile device associated with the customer.

In some embodiments, the computer-executable instructions are further to cause the processing device to initiate creation of a physical card corresponding to the electronically transmitted new card number; and initiate shipping of the created physical card to a physical address associated with the customer. In some embodiments, the electronically transmitted new card number is configured for use as a payment instrument. In some embodiments, the new card number is electronically transmitted to a mobile wallet application running on the mobile device associated with the customer. In some embodiments, the customer request for a new card number comprises a customer request for a new card number associated with a new account; and wherein the computer-executable instructions are further to cause the processing device to determine that the customer has been pre-approved for a new account; initiate opening of the new account; initiate creation of a physical card corresponding to the electronically transmitted new card number and the new account; and initiate shipping of the created physical card to a physical address associated with the customer.

In some embodiments, the computer-executable instructions are further to cause the processing device to initiate creation of a physical card having a physical card number different from the electronically transmitted new card number; initiate shipping of the created physical card to a physical address associated with the customer; wherein the electronically transmitted new card is configured to expire after a period of time. In some such embodiments, the period of time is based at least in part on a shipping time associated with the created physical card or activation of the created physical card.

According to embodiments of the invention, a computer-implemented method uses a computer processor operating computer program code instructions stored in a non-transitory computer readable medium, wherein the computer program code instructions cause the computer processor to receive a customer request for a new card number; and electronically transmit the new card number to a mobile device associated with the customer.

In some embodiments, the computer program code instructions further cause the computer processor to initiate creation of a physical card corresponding to the electronically transmitted new card number; and initiate shipping of the created physical card to a physical address associated with the customer. In some embodiments, the electronically transmitted new card number is configured for use as a payment instrument. In some embodiments, the new card number is electronically transmitted to a mobile wallet application running on the mobile device associated with the customer. In some embodiments, the customer request for a new card number comprises a customer request for a new card number associated with a new account; and wherein the computer program code instructions further cause the computer processor to determine that the customer has been pre-approved for a new account; initiate opening of the new account; initiate creation of a physical card corresponding to the electronically transmitted new card number and the new account; and initiate shipping of the created physical card to a physical address associated with the customer.

In some embodiments, the computer program code instructions further cause the computer processor to initiate creation of a physical card having a physical card number different from the electronically transmitted new card number; initiate shipping of the created physical card to a physical address associated with the customer; wherein the electronically transmitted new card is configured to expire after a period of time. In some such embodiments, the period of time is based at least in part on a shipping time associated with the created physical card or activation of the created physical card.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a block diagram of an environment in which systems operate according to embodiments of the present invention;

FIG. 2 is a flowchart illustrating a method 200 for providing a new card number to a customer according to embodiments of the invention;

FIG. 3 is a flowchart illustrating another method 300 for providing a new card number to a customer according to embodiments of the invention;

FIG. 4 is a flowchart illustrating another method 400 for providing a new card to a customer according to embodiments of the invention; and

FIG. 5 is a flowchart illustrating another method 500 for providing a new card to a customer according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention provide a system that provides a new card number to a customer by receiving a customer request for a new card number and electronically transmitting the new card number to a mobile device associated with the customer. In some cases, the system initiates creation of a physical card corresponding to the electronically transmitted new card number; and initiates shipping of the created physical card to a physical address associated with the customer. In some cases, the new card number is electronically transmitted to a mobile wallet application running on the mobile device associated with the customer. The request may include a customer request for a new card number associated with a new account, and the system determines that the customer has been pre-approved for a new account, initiates opening of the new account and initiates creation of a physical card corresponding to the electronically transmitted new card number and the new account.

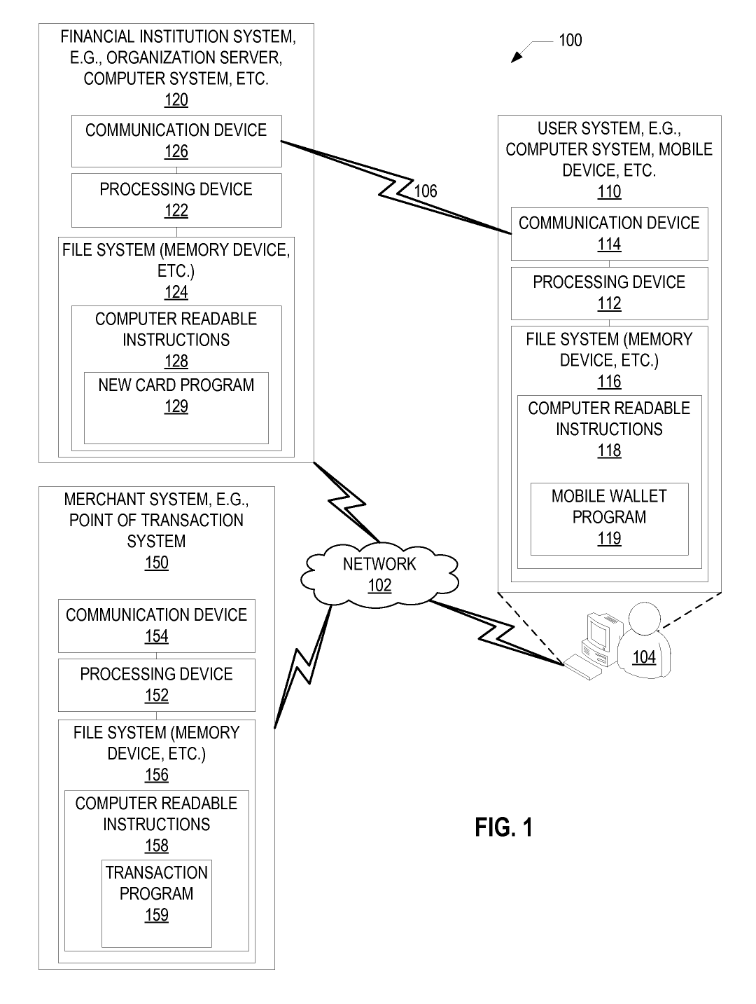

Referring now to FIG. 1, a block diagram of environment 100, in which systems operate according to embodiments of the present invention is shown. FIG. 1 illustrates an environment 100 in which the financial institution system 120, the user system 110 and the merchant system 150 interact over a network 102. Each of the systems 120 and 150 communicate over the network 102 with the user system 110. In some embodiments, one or more of the systems 110, 120, and/or 150 communicate directly with one another.

In the various embodiments, the user system 110 is a computer system, mobile device or other computing device used by a client 104 or other user to interact with an organization's online content and applications, such as by communicating with the financial institution system 120. The user system 110 includes, in the embodiment shown, a processing device 112 communicatively coupled with a communication device 114 and a file system 116. The processing device, in some embodiments, is configured for controlling operation of the communication device 114 in order to communicate across the network 102, such as, for example, with the financial institution system 120 and/or the merchant system 150. The file system 116 is or includes a memory device or other memory configured for storing computer readable instructions 118 such as an operating system, applications, such as a browser and others, other computer program code and the like. In some embodiments, the computer readable instructions include a mobile wallet program 119 or application configured for instructing the processing device 112 to perform one or more of the methods and/or steps discussed herein and/or perform one or more transactions such as with a point of transaction or point of sale of a merchant. The mobile wallet program 119, in some embodiments, is configured for instructing the processing device 112 to communicate with the financial institution system, 120 and/or the merchant system 150 either directly or over one or more external networks such that the user device may communicate messages from the user of the user system and/or potentially complete a transaction, among other things. The processing device 112, of course, is configured for accessing and/or retrieving some or all the computer readable instructions 118 and executing some or all of them.

In one embodiment, for example, the network 102 is an intranet or other local area network (LAN) and the user system 110, the financial institution system 120, and the merchant system 150 are all part configured for communicating with one another across the intranet. In such an embodiment, the user system, when directed by the user 104 to access a particular intranet webpage, uses a browser program to navigate to the intranet webpage. The browser then requests online interaction, such as webpage content, from the financial institution system 120.

The financial institution system 120, in some embodiments, is a server such as an organization server. In some embodiments, the financial institution location system 120 is maintained and/or owned by a financial institution such as a bank. In some such cases, the financial institution system 120 is considered part of one or more backend systems of the bank. The financial institution system 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the user system 110 and/or the merchant system 150. The file system 124 is configured for storing computer readable instructions 128, such as, for example, the new card program 129, an operating system, other applications, other computer executable program code and the like. The new card program 129 includes program code and/or instructions for performing one or more of the methods and/or method steps discussed herein. For example, in one embodiment, the new card program 129 is configured for instructing the processing device 122 to communicate with the user device 110 either directly or over one or more external networks such that the user device may connect with the financial institution system 120 to transmit communications such as requests for a new card and/or to transmit a new card to the mobile wallet program 119 of the user device 110. The processing device 122, of course, is configured to access and/or retrieve some or all the computer readable instructions 128 and execute some or all of them.

The merchant system 150 is, in some embodiments, a server such as an organization server, a computer system, another computing device or the like. In some embodiments it includes or is a point of sale device or point of transaction device. The merchant system 150, in some embodiments, includes a processing device 152 communicatively coupled with a communication device 154 and a file system 156. The processing device 152 is typically configured to control the communication device for communicating across the network 102 with one or more of the other systems, such as the financial institution system 120 and/or the user system 110. The file system 156 is configured for storing computer readable instructions such as a transaction program 159, an operating system, other computer executable program code, applications and the like. The processing device 152 is configured for accessing and/or retrieving some or all the computer readable instructions 158 from the file system 156 and executing some or all of them. In some embodiments, for example, the transaction program 159 includes program code configured to instruct the processing device 152 communicate with the user device 110 either directly or over one or more external networks in order to complete a transaction with the user of the user device 110 or otherwise interact.

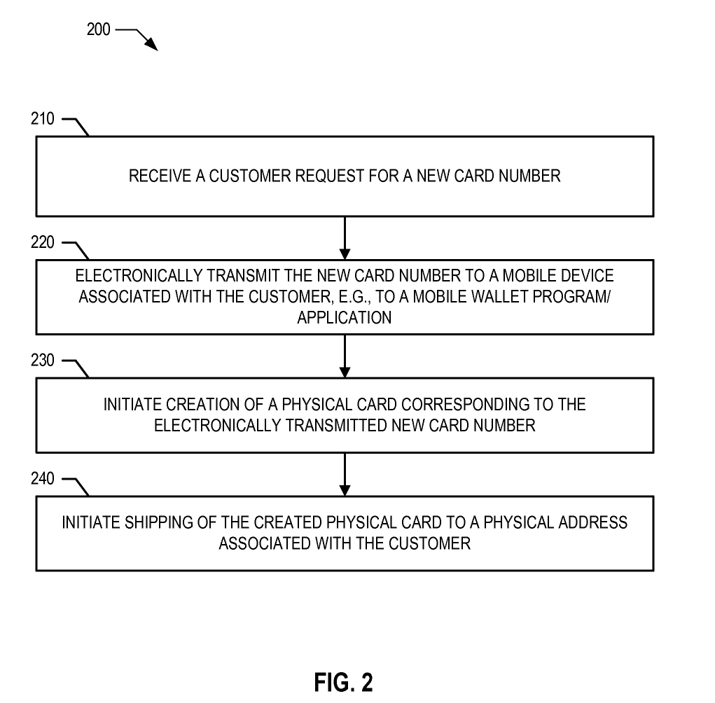

Referring now to FIG. 2, a flowchart illustrates a method 200 for providing a new card number to a customer according to embodiments of the invention. The first step, represented by block 210, is to receive a customer request for a new card number. This request may be transmitted from a user's mobile device, such as by a mobile wallet program, online banking program or otherwise. The request may be transmitted in other ways as well, such as by another user device such a computer through an online banking website. The request is received by a system, such as a financial institution system from the user device transmitting the request.

The next step, represented by block 220, is to electronically transmit a new card number to a mobile device associated with the customer. For example, the new card may be transmitted to the mobile wallet program running on the mobile device of the user. This new card number may be generated and transmitted in response to the user request for a new card number. The user's request for a new card number may be because the user has lost a previous card, that the user desires a new card number associated with a new account (as discussed further below) or otherwise.

The next step, represented by block 230, is to initiate creation of a physical card corresponding to the electronically transmitted new card number. In some embodiments, the electronically transmitted new card number is the same as the physical card that is created and, in that regard, they are linked. However, in some embodiments, the electronically transmitted new card number is different than the physical card that is created.

The next step, represented by block 240 is to initiate shipping of the created physical card to a physical address associated with the customer.

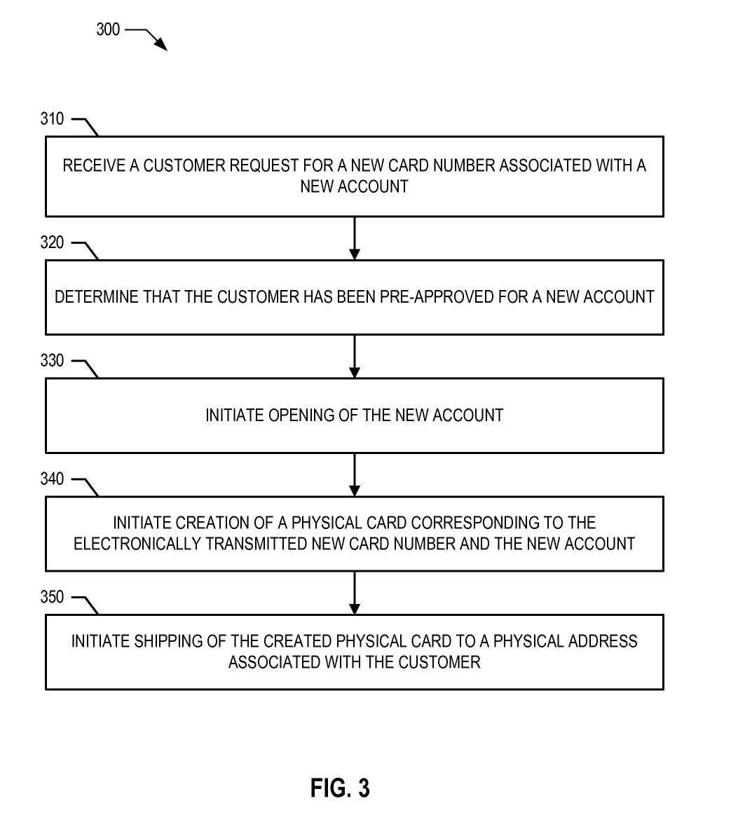

Referring now to FIG. 3, a flowchart illustrates another method 300 for providing a new card number to a customer according to embodiments of the invention. The first step, represented by block 310, is to receive a customer request for a new card number associated with a new account. The next step, represented by block 320, is to determine that the customer has been pre-approved for a new account. The customer may have previously requested, such as by an online banking program or by a mobile wallet program to be approved or pre-approved for a new debit and/or credit account. In some instances, the financial institution may have unilaterally pre-approved a customer for one or more new debit and/or credit accounts without a request from the customer. In other cases, where a pre-approval has not been performed, the method may include steps such as forwarding the customer to an application entry page for submission of the customer's application for a new account. In yet other embodiments, the method may include pulling necessary information from a user's stored profile, such as from an online banking profile to complete an application for a new debit/credit account and proceed through the approval or denial process.

In such a case, as represented by block 330, the next step is to initiate opening of the new account. The next step, once a new account has been opened, is to initiate creation of a physical card corresponding to the electronically transmitted new card number and the new account, as represented by block 340 and to initiate shipping of the created physical card to a physical address associated with the customer, as represented by block 350.

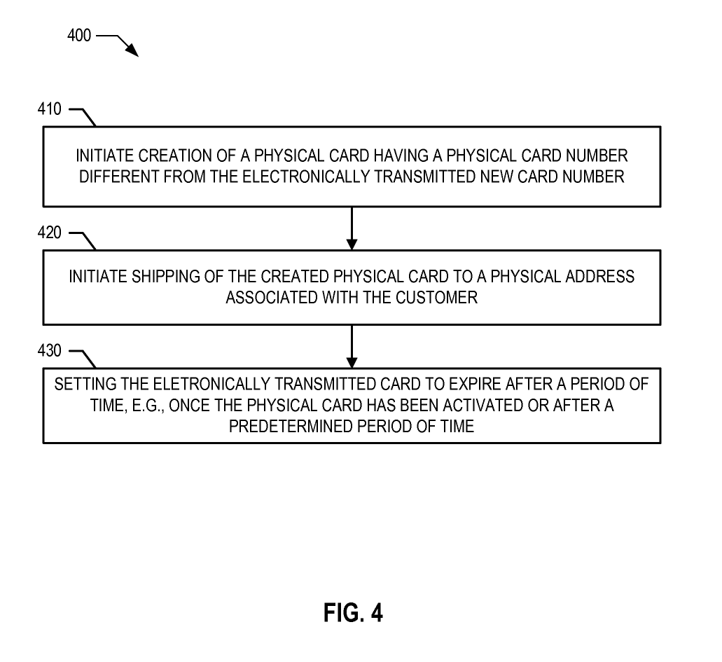

Referring now to FIG. 4, a flowchart illustrates another method 400 for providing a new card to a customer according to embodiments of the invention. As mentioned above, in some embodiments, a physical card having a physical card number different from the electronically transmitted new card number is created and shipped to a physical address associated with the customer, as represented by blocks 410 and 420, respectively. The next step, represented by block 430, in some embodiments, is setting the electronically transmitted card to expire after a period of time. For example, the period of time may be associated with activation of the physical card by the customer, such that, once the physical card has been activated, the financial institution cancels the electronically transmitted card.

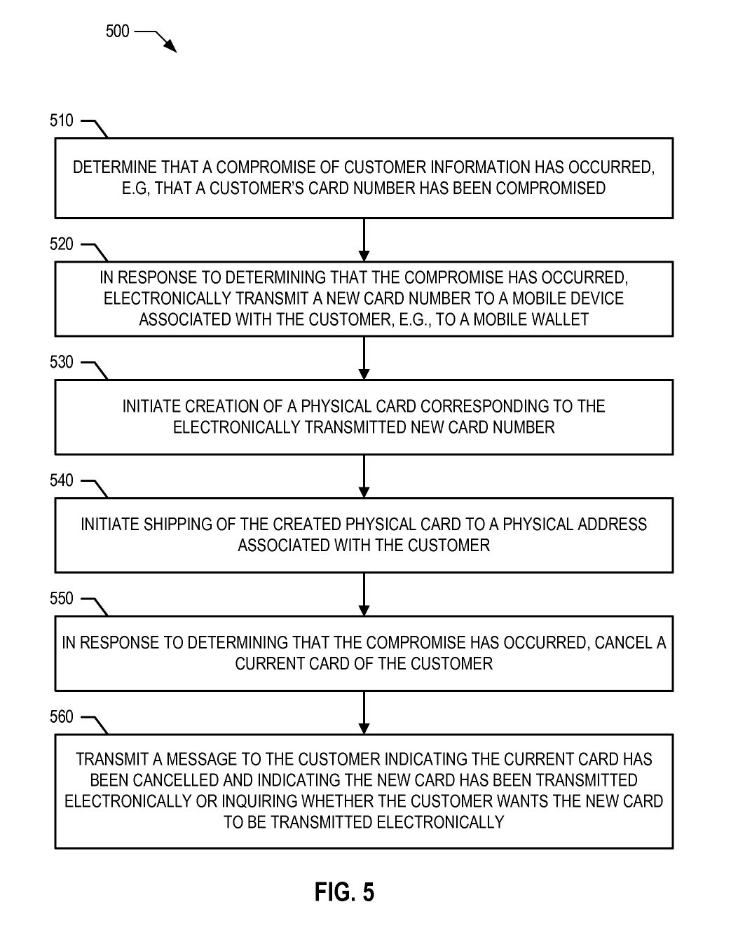

Referring now to FIG. 5, a flowchart illustrates another method 500 for providing a new card to a customer according to embodiments of the invention. The first step, represented by block 510, is to determine that a compromise of customer information has occurred, for example, that a customer's card number has been compromised. The financial institution system 120 may make this determination based on information it knows or receives from other financial institution systems or from merchant systems, such as merchant system 150 or otherwise. The next step, represented by block 520, is in response to determining that the compromise has occurred, to electronically transmit a new card number to a mobile device associated with the customer. For example, the new card number may be electronically transmitted to a mobile wallet program running on the customer's mobile device.

The next step, represented by block 530, is to initiate creation of a physical card corresponding to the electronically transmitted new card number. The next step, represented by block 540, is to initiate shipping of the created physical card to a physical address associated with the customer. The next step, represented by block 550, is to cancel, in response to determining that the compromise has occurred, a current card of the customer. The last step, represented by block 560, is to transmit a message to the customer indicating the current card has been cancelled and indicating the new card has been transmitted electronically. In other embodiments, the method may include transmitting a message to the customer indicating the current card has been cancelled and inquiring whether the customer wants a new card to be transmitted electronically.

In some embodiments, multiple factor authentication may be used by the invention. For example, two-factor authentication may be used in order to use an electronically delivered card number. One such implementation may be to require a PIN be entered by the user in order for the delivered card number to be used, such as by a mobile wallet. In order for a transaction to be completed, the financial institution may require the merchant to receive a PIN or other authentication. In such a case, the merchant may receive the PIN or other authentication from the user and forward it to the financial institution for authentication. In other cases, the secondary authentication may be based on an encoded, embedded or other mechanism that is secured so that a user cannot access the mechanism using the mobile device, and the secondary authentication is performed by the mobile device.

In some embodiments, the electronically delivered new card is a temporary card that will be deactivated when the customer receives and activates a new physical card or after a period of time such as a predetermined period of time corresponding to the expected period of time it takes the customer to receive a shipped physical new card. In other embodiments, the electronically delivered new card may be a pre-paid card, such as a card having a limited amount of funds associated with the card such as a pre-paid card having $100.00 associated with it. In some such embodiments, the customer may purchase a pre-paid card, such as by using the customer's mobile wallet or online banking website and then purchased pre-paid card may be electronically delivered according to embodiments of the invention.

The invention may allow for the customer to receive their new card electronically over a secure digital, mobile interface such as a financial institution's mobile wallet or application. This electronically delivered card may be visible immediately in the customer's mobile wallet and can be used for online and physical purchases. For example, when the customer is conducting a transaction with a merchant, the mobile wallet may present the electronically delivered card to the merchant in a visual format. The merchant can then enter the number into the POS or POT for payment. In some such embodiments, secondary authentication may be used such as requiring the user to enter PIN or otherwise.

In some embodiments, the electronically delivered card includes a CVC code and/or any other information traditionally stored on a physical bank card.

In some embodiments, the PIN associated with the electronically delivered card may change when the customer's physical card is delivered. This provides an opportunity to have a unique PIN for temporary usage in conjunction with the electronically delivered card.

In some embodiments, the customer may be travelling and require a new card due to a lost card. Travel restrictions may be applied to use of the electronically delivered card functionality as described herein. For example, if there is a suspected security problem, then electronic delivery to the potentially compromised mobile wallet, for example, may be prevented until the security issue is cleared.

In summary, embodiments of the invention include a system that provides a new card number to a customer by receiving a customer request for a new card number and electronically transmitting the new card number to a mobile device associated with the customer. In some cases, the system initiates creation of a physical card corresponding to the electronically transmitted new card number; and initiates shipping of the created physical card to a physical address associated with the customer. In some cases, the new card number is electronically transmitted to a mobile wallet application running on the mobile device associated with the customer. The request may include a customer request for a new card number associated with a new account, and the system determines that the customer has been pre-approved for a new account, initiates opening of the new account and initiates creation of a physical card corresponding to the electronically transmitted new card number and the new account.

Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

Further, the embodiments described herein may refer to use of a transaction or transaction event. Unless specifically limited by the context, a “transaction” refers to any communication between the user and a merchant, financial institution, insurance company, or other entity. A “transaction” may also include a bill, statement, purchase at a POT, online purchase, purchase at a merchant, and/or the like. For example, in some embodiments, a transaction may include one or more of the following: purchasing, renting, leasing, bartering, selling, and/or leasing goods and/or services (e.g., groceries, stamps, tickets, DVDs, vending machine items, or the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like. For example, a transaction may occur when a user purchases a product at a merchant. In yet other embodiments, for example, a transaction may occur when an entity associated with the user is alerted. A transaction may occur when a user accesses a building, uses a rewards card, and/or performs an account balance query. A transaction may occur as a user's device establishes a wireless connection, such as a Wi-Fi connection, with a point-of-transaction terminal.

In still further embodiments, a transaction may refer to an event and/or action or group of actions facilitated or performed by a user's device, such as a user's mobile system, a merchant system, and/or a combination thereof. A device capable of facilitating or performing a transaction may be referred to herein as a “POT system” or “POT device.” A “point-of-transaction” or “POT” could refer to any location, virtual location or otherwise proximate occurrence of a transaction. A POT system may refer to any device used to perform a transaction, either from the user's perspective, the merchant's perspective or both. In some embodiments, the POT system refers only to a user's system, in other embodiments it refers only to a merchant system, and in yet other embodiments, it refers to both a user device and a merchant device interacting to perform a transaction. For example, in one embodiment, the POT system refers to the user's mobile device configured to communicate with a merchant's system, whereas in other embodiments, the POT system refers to a merchant's system configured to communicate with a user's mobile device, and in yet other embodiments, the POT system refers to both the user's mobile device and the merchant's system configured to communicate with each other to carry out a transaction.

In some embodiments, a POT system is or includes an interactive computer terminal that is configured to initiate, perform, complete, and/or facilitate one or more transactions. A POT system could be or include any device that a user may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a POT system is operated in a public place (e.g., on a street corner, at the doorstep of a private residence, in an open market, at a public rest stop, or the like). In other embodiments, the POT system, is additionally or alternatively operated in a place of business (e.g., in a retail store, post office, banking center, grocery store, factory floor, or the like). In accordance with some embodiments, the POT system is not owned by the user of the POT system. Rather, in some embodiments, the POT system is owned by a mobile business operator or a POT operator (e.g., merchant, vendor, salesperson, or the like). In yet other embodiments, the POT system is owned by the financial institution offering the POT system providing functionality in accordance with embodiments of the invention described herein.

As used herein, a “bank card” refers to a credit card, debit card, ATM card, check card, or the like, or other payment device such as, but not limited to, those discussed above that are not cards. An “account” or “bank account” refers to a credit account, debit account, deposit account, demand deposit account (DDA), checking account, budgeting account or the like. Although the phrases “bank card” and “bank account” include the term “bank,” the card or payment device need not be issued by a bank, and the account need not be maintained by a bank and may instead be issued by and/or maintained by other financial institutions.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

1. A system for providing a new card number to a customer, the system comprising:
a memory device storing computer executable code;
a processing device to execute the computer executable code to cause the processing device to:
receive a customer request for a new card number;
electronically transmit the new card number to a mobile device associated with the customer;
initiate creation of a physical card having a physical card number different from the electronically transmitted new card number;
initiate shipping of the created physical card to a physical address associated with the customer;
wherein the electronically transmitted new card is configured to expire after a period of time; and
wherein the period of time is based at least in part on a shipping time associated with the created physical card or activation of the created physical card.

2. The system of claim 1, wherein the computer executable code is further to cause the processing device to:
initiate creation of a physical card corresponding to the electronically transmitted new card number; and
initiate shipping of the created physical card to a physical address associated with the customer.

3. The system of claim 1, wherein the electronically transmitted new card number is configured for use as a payment instrument.

4. The system of claim 1, wherein the new card number is electronically transmitted to a mobile wallet application running on the mobile device associated with the customer.

5. The system of claim 1, wherein the customer request for a new card number comprises a customer request for a new card number associated with a new account; and
wherein the computer executable code is further to cause the processing device to:
determine that the customer has been pre-approved for a new account;
initiate opening of the new account;
initiate creation of a physical card corresponding to the electronically transmitted new card number and the new account; and
initiate shipping of the created physical card to a physical address associated with the customer.

6. (canceled)

7. (canceled)

8. A computer program product configured for providing a new card number to a customer, the computer program product comprising a non-transitory computer readable medium comprising computer-executable instructions stored therein, the computer-executable instructions to cause a processing device to:
receive a customer request for a new card number;
electronically transmit the new card number to a mobile device associated with the customer;
initiate creation of a physical card having a physical card number different from the electronically transmitted new card number;
initiate shipping of the created physical card to a physical address associated with the customer;
wherein the electronically transmitted new card is configured to expire after a period of time; and
wherein the period of time is based at least in part on a shipping time associated with the created physical card or activation of the created physical card.

9. The computer program product of claim 8, wherein the computer-executable instructions are further to cause the processing device to:
initiate creation of a physical card corresponding to the electronically transmitted new card number; and
initiate shipping of the created physical card to a physical address associated with the customer.

10. The computer program product of claim 8, wherein the electronically transmitted new card number is configured for use as a payment instrument.

11. The computer program product of claim 8, wherein the new card number is electronically transmitted to a mobile wallet application running on the mobile device associated with the customer.

12. The computer program product of claim 8, wherein the customer request for a new card number comprises a customer request for a new card number associated with a new account; and
wherein the computer-executable instructions are further to cause the processing device to:
determine that the customer has been pre-approved for a new account;
initiate opening of the new account;
initiate creation of a physical card corresponding to the electronically transmitted new card number and the new account; and
initiate shipping of the created physical card to a physical address associated with the customer.

13. (canceled)

14. (canceled)

15. A computer-implemented method for providing a new card number to a customer, the method comprising:
using a computer processor operating computer program code instructions stored in a non-transitory computer readable medium, wherein the computer program code instructions cause the computer processor to:
receive a customer request for a new card number;
electronically transmit the new card number to a mobile device associated with the customer;
initiate creation of a physical card having a physical card number different from the electronically transmitted new card number;
initiate shipping of the created physical card to a physical address associated with the customer;
wherein the electronically transmitted new card is configured to expire after a period of time; and
wherein the period of time is based at least in part on a shipping time associated with the created physical card or activation of the created physical card.

16. The method of claim 15, wherein the computer program code instructions further cause the computer processor to:
initiate creation of a physical card corresponding to the electronically transmitted new card number; and
initiate shipping of the created physical card to a physical address associated with the customer.

17. The method of claim 15, wherein the electronically transmitted new card number is configured for use as a payment instrument.

18. The method of claim 15, wherein the new card number is electronically transmitted to a mobile wallet application running on the mobile device associated with the customer.

19. The method of claim 15, wherein the customer request for a new card number comprises a customer request for a new card number associated with a new account; and
wherein the computer program code instructions further cause the computer processor to:
determine that the customer has been pre-approved for a new account;
initiate opening of the new account;
initiate creation of a physical card corresponding to the electronically transmitted new card number and the new account; and
initiate shipping of the created physical card to a physical address associated with the customer.

20. (canceled)

21. (canceled)
